(19) United States
(12) Patent Application Publication
(10) Pub. No.: US 2014/0116116 A1
(43) Pub. Date: May 1, 2014

(54) METHODS FOR TESTING AND ASSESSING ASPHALT CONCRETE MIXTURE WORKABILITY AND COMPACTABILITY

(71) Applicant: Pine Instrument Company, Grove City, PA (US)

(72) Inventor: Rajendra Nidhish DONGRE, McLean, VA (US)

(73) Assignee: Pine Instrument Company, Grove City, PA (US)

(21) Appl. No.: 14/065,946

(22) Filed: Oct. 29, 2013

Related U.S. Application Data
(60) Provisional application No. 61/719,715, filed on Oct. 29, 2012.

(51) Int. Cl. G01N 11/00

(52) U.S. Cl. CPC G01N 11/00
USPC 73/54.03

(57) ABSTRACT

Methods of design, testing and quality control for asphalt concrete pavement mixtures.

### RELATED APPLICATIONS

This application claims benefit of U.S. Provisional Patent Application No. 61/719,715 filed Oct. 29, 2012.

### BACKGROUND OF THE INVENTION

Workability, in the application of asphalt concrete mixtures, refers to a material characteristic determining the effort required to manipulate an un-compacted material with minimum loss of homogeneity. The term manipulate, as used herein, refers to operations such as mixing, handling, and placement at the construction site. A pavement mixture such as an asphalt concrete mixture that requires relatively less effort (lower force) has a higher workability than a mixture which requires relatively more effort (higher force) to be directed into the desired shape. A term related to workability used within the pavement industry is compactability, which relates to the materials behavior during the consolidation process of pavement construction. Workability is related to the mixing and placing processes, while compactability is related to the effort required to achieve consolidation in an unconfined condition during construction. Workability and compactability are interrelated temperature dependent characteristics for asphalt concrete mixtures. However, mixtures with the same workability may not have the same compactability. Construction temperatures for asphalt concrete mixtures are selected such that the material can be placed as needed and compacted to design densities in an unconfined condition.

Asphalt concrete mixtures, used primarily as pavement materials, consist of coarse and fine aggregate, and asphalt binder. Asphalt concrete pavement, refers to the bound layers of a flexible pavement structure in contrast to Portland cement concrete which is a rigid pavement structure. In many applications, asphalt concrete mixtures are placed at elevated temperatures and referred to as hot mix asphalt (HMA).

Warm-mix asphalt (WMA) is similar to HMA and usually includes additives such as zeolites, waxes, asphalt emulsions, or sometimes water in the asphalt binder. These additives act as coating, mixing, and lubrications aids enabling significantly lower mixing and compaction temperatures than HMA. These lower temperatures result in lower consumption of fuels, thus releasing less carbon dioxide, aerosols and vapors during construction. The lower temperatures realized by the use of these additives also improve pavement construction working conditions. An additional benefit to the WMA process is rapid opening of the pavement to traffic, which reduces the impact of the pavement construction or repair on the public's transportation needs. The use of these additives also extend the paving season into cold weather months and enables extended transport distances from the production plant to the construction site. The lower construction temperatures facilitated by the WMA processes contribute to a need to understand the asphalt concrete mixture rheological characteristics at lower temperatures. Understanding these characteristics prior to construction provides insight into the effectiveness of the WMA processes.

Current techniques for evaluating the rheological characteristics of the materials used in the WMA process rely on binder tests. These tests evaluate the binder viscosity, lubricity, or shearing properties to estimate the response of the material during construction. Traditionally, mixing and compaction temperatures for use in laboratory mix design were determined from binder viscosity measured at two temperatures (135° C. and 165° C.). With the increasing use of polymer modified asphalt mixes, the traditional binder viscosity based determinations of mixing and compaction temperatures result in overestimating the temperatures. Because of this limitation, researchers have sought alternative methods to determine mixing and compaction temperatures of polymer modified asphalt mixes. Examples of these alternatives include test methods based on zero-shear viscosity, high shear viscosity, shear flow viscosity, and the phase angle method. However, the asphalt concrete mixture coarse and fine aggregate structure contributes significantly to the workability and compactability of the material. These binder tests fail to account for aggregate contribution to workability and compactability of the mixture.

The economies of utilizing local materials for pavement construction make it highly desirable to make use of local mineral aggregate supplies. There is currently a lack of accepted test methods to measure mixture workability in the laboratory prior to construction and experience with the constituent materials is relied, upon for guidance. As material sources with known characteristics are consumed and new sources employed, experience with these new materials is limited. As a result, pavement test strips are often used prior to the roadway construction to determine the requirements to place and compact these new materials. These test strips facilitate determining the limits of workability and compactability of the material. These limits include temperatures such as where the material consolidates rather than flows and points where the material is more likely to flow than consolidate.

Other asphalt concrete mixture constituents such as reclaimed asphalt pavement (RAP) and Recycled Asphalt Shingles (RAS) provide economies to asphalt concrete mixtures by making use of the aggregate and the available bituminous material these materials contain. However, the use of these constituents in an asphalt concrete mixture can influence its workability and compactability during construction and thus a clear understanding of the impact on construction is important to the application of such recycled materials.

An example of an attempt to obtain information on the workability of asphalt concrete mixtures is disclosed in U.S. Patent Application 2010/0011841 A1 Mogawer, et al. The disclosed device utilizes a bucket with a mixing paddle. As the bucket is rotated, the mixing paddle engages the material sample. The torque required to resist the turning of the mixing paddle is utilized to obtain a measurement of the workability. However, during the shearing process the paddles engaging the material create an open pocket where the paddle exists. This creates significant error in the measurement because there is no test material interacting with the mixing paddle. Another disadvantage of this device is that it requires a large amount of material which is problematic for laboratory testing. Also, as noted previously, workability is a temperature dependent characteristic. The large material sample, open container, and long test time make it difficult to keep the specimen at a uniform temperature throughout the test. The resulting temperature non-uniformities further impact the results. The torque measuring bucket mixer type device does not adequately account for the aggregate skeletal structure that develops during pavement construction as the asphalt mixture consolidates.

Other mix based workability devices include the Nynas device, the University of New Hampshire Device, and Gyratory Shear force measurement. Table 10 of the National Cooperative Highway Research Program Report 691 “Mix Design Practices for Warm Mix Asphalt” list the advantages and disadvantages of current workability measurement techniques in tabular form. This report found that these devices only differentiate workability of WMA from HMA at temperatures much lower than those associated with WMA applications.

TABLE 10
Key elements of potential workability devices for WMA.

| | | Modification of | | |
|---|---|---|---|---|
| Device | Measurement | Procedure Needed for WMA | Advantages | Disadvantages |
| NCAT Prototype | Torque to rotate paddle at | None | Measure workability | Requires new |
| Workability Device | constant speed. | | during mixing. | mixer. |
| | | | Previous research. | |
| UMass Prototype | Torque to rotate an auger at | None | Measure workability | Requires new |
| Workability Device | constant speed. | | during mixing. | mixer. |
| | | | Augur may better | |
| | | | represent field movement. | |
| Modified Nynäs | Force to push a blade into a | Temperature control at | Simulates screed action. | Requires new |
| Workability Device | loose mix sample. | WMA placement and | Relatively inexpensive. | device. |
| | | compaction temperatures. | | |
| ASTM D6704 | Force to push a blade into a | Temperature control at | Simple and inexpensive. | May not represent |
| | loose mix sample. | WMA placement and | Uses existing equipment. | field conditions. |
| | | compaction temperatures. | | |
| Gyratory Shear | Shear stress during | None for gyratory | Measure workability | Requires gyratory |
| Stress | gyratory compaction. | compactors with this | during compaction. | compactor with |
| | | capability. | | shear stress |
| | | | | measurement. |
| University of New | Torque using blade | None | Simple and inexpensive. | Blade and drill |
| Hampshire | attached to hand drill with | | Can easily be performed | torque settings need |
| | adjustable torque settings. | | after mixing or prior to | to be standardized. |
| | | | compaction. | |

ASTM D6704 Standard Test Method for Determining the Workability of Asphalt Cold Mix Patching Material describes a method and apparatus in which the material is evaluated at temperatures below freezing making the method unsuitable for use with WMA or HMA applications.

Quality control measures employed for assessing the conformity of asphalt concrete mixture properties as produced to design requirements often rely on the volumetric properties of material samples. These measures assume that changes in the mixture constituents reflected in the volumetric property will reflect the performance characteristics of the material samples. To gain additional conformance measures, strength tests may be utilized to examine the structural properties of the plant produced material. However, these tests require tedious specimen preparation techniques and can take many hours to complete. While these performance tests provide useful quality assurance information for the material, they do not provide information that can be used in a timely manner to make component adjustments during production. In addition to assessing workability, the methodology described in this document provides a simple and quick measure that reflects changes in the mixture constituents providing valuable information that can be applied quickly for quality control management. The signal reflects changes to aggregate structure as well as binder properties and compaction aid additive levels.

### SUMMARY OF THE DISCLOSURE

The methods and apparatus disclosed herein provide means for characterizing materials and mixtures of materials, such as asphalt concrete mixtures, in the laboratory prior to construction and thus can be used to predict appropriate construction temperatures without requiring construction of test strips. Because the disclosed methods include all mixture components in the testing sequence, it is sensitive to material changes in aggregate and binder during production making the technique applicable as a quality control measure. Many pavement engineering and design laboratories already own the equipment required to perform this method making the technique a useful and novel tool to the pavement industry. While this description focuses on asphalt pavement mixes, those skilled in the art will recognize the application to other materials.

Asphalt concrete is a composite material composed of randomly oriented aggregates held together by an asphalt adhesive. At low temperatures and/or fast loading rates, the composite behaves elastically where at high temperatures and/or slow loading rates the composite exhibits viscoelastic behavior. The behavior is thus a function of testing temperature and loading rate as well as the relative proportions of the individual constituents. This temperature/loading rate behavior can be leveraged with a time-temperature transform function to predict behavior at different temperatures from testing a different loading rates as well as predicting behavior at different loading rates from testing at different temperatures. The methods include prediction of material characteristics by testing at multiple loading rates or at multiple temperatures.

A preferred and exemplary embodiment of the method of the present invention provides a simple laboratory test for evaluating asphalt concrete pavement mixture compactability and workability. The results can be used to predict material rheological characteristics at various temperatures aiding the selection of appropriate production and construction temperatures. This test can be performed on a modified Superpave Gyratory Compactor (SGC) or other suitable loading frame meeting the requirements outlined in the apparatus section.

As used herein, the term, compactability, refers to and generally means a rheological characteristic of an un-compacted asphalt pavement mixture describing how much effort is required to achieve consolidation in an unconfined condition. For example, the effort required to achieve consolidation influences when the material can be properly consolidated without flowing and thus impacts construction rolling techniques. Compactability is a temperature dependent characteristic for asphalt pavement mixtures.

As used herein, the term, workability, refers to and generally means a rheological characteristic determining the effort required to manipulate an un-compacted asphalt pavement mixture with minimum loss of homogeneity. As used herein, the term manipulate refers to operations such as mixing, handling, and placement at the construction site. A mixture that requires relatively less effort (lower force) has a higher workability than a material which requires relatively more effort (higher force) to be directed into the desired shape. Workability is a temperature dependent characteristic for asphalt pavement mixtures.

A pavement material specimen, conditioned at a pre-described temperature, is confined to a cylindrical steel mold while a consolidation pressure is applied at controlled travel rates (rate of strain). The resulting stress versus strain response of the material is used to determine an index value representing the relative workability of the material at the test temperature. Materials are typically tested at more than one temperature and different loading rates may be employed over the testing range.

The workability value obtained in this test provides a relative index ranking the behavior of the loose material related to the effort required to place and compact the material during construction. The index can indicate the relative temperature performance of materials and may be applicable for predicting appropriate production and construction temperatures. Lower production and construction temperatures result in energy savings, lower emissions which reduce workers exposure to harmful vapors, and also contribute to the reduction in the release of pollutants to the environment.

Results of materials tested at multiple temperatures utilized to predict lower construction temperatures can be applied to extend haul or transport distances, expand ambient temperature limitations during placement (extend paving season), and determine construction requirements for proper placement without test strips to determine rolling requirements. The results are also applicable for evaluating the warm mix additive levels and the effectiveness of such additives.

The information extracted during the test is also applicable to quality control procedures utilized to monitor production materials meet design requirements and consistency specifications. The signal may reflect changes to aggregate structure as well as binder quality, additive levels, and changes to other constituents, such as reclaimed asphalt pavement and recycled asphalt shingles.

As used herein, the term or name loading system refers to and means a system, apparatus or device that is generally capable of applying a force at a programmed rate of travel (velocity or strain rate) to a material specimen confined in a container or apparatus such as for example a cylindrical mold of known diameter, while simultaneously measuring and recording the applied force (or stress), height of the material specimen, and time index. A typical or exemplary loading system may include, for example, an electromechanical, electro-hydraulic, or electro-pneumatic instrument comprised of the following system components: reaction frame, drive system, loading platen, force indicating and recording system, position indicating and recording system, mold and mold end plates. Some models of SUPERPAVE Gyratory Compactor (SGC) modified to operate to the specified protocol have proven to be acceptable loading systems.

### BRIEF DESCRIPTIONS OF THE DRAWINGS

FIG. 1 is a schematic view of a force loading system such as a Superpave Gyratory Compactor which can be used in connection with the disclosed methods and related inventions;

FIG. 2 is a plot of stress v. volumetric strain of an asphalt concrete mixture determined in accordance with the disclosed methods and related inventions;

FIG. 3 is plot of temperature v. DWT of an asphalt concrete mixture determined in accordance with the disclosed methods and related inventions and described in Table 3, and

FIG. 4 is a plot of DWT workability v. temperature measurements determined in accordance with the disclosed methods and related inventions.

### DETAILED DESCRIPTION OF PREFERRED EMBODIMENTS OF THE DISCLOSURE AND RELATED INVENTIONS

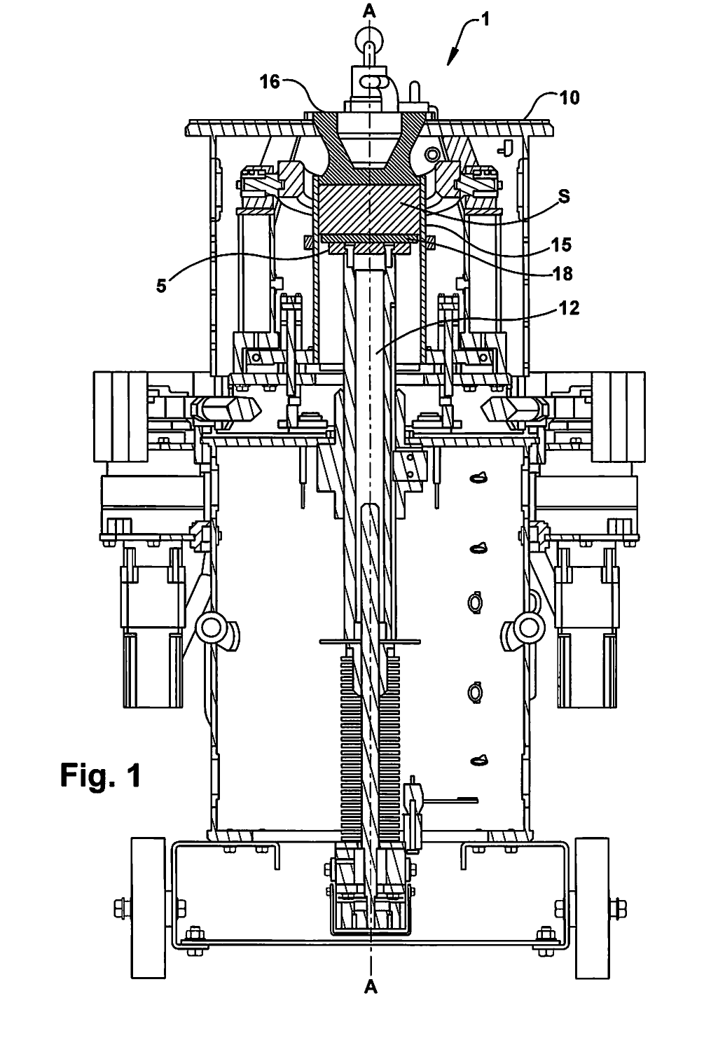

FIG. 1 is a representation of an SGC utilized as a loading system, indicated generally at 1. The loading system and force indicator is generally capable of applying and measuring a vertical force of 18 kN which corresponds to 1000 kPa on a 150 mm diameter specimen. The axis A of the loading ram 12 is generally perpendicular to the platen 5 and loading frame 10. A movable end plate 18 may be provided, for example by contact with the platen 5. The force measurement and recording system are generally capable of measuring and recording the force to the nearest 10 Newton (pressure to the nearest 0.5 kPa).

The loading system is capable of providing a programmable rate of travel of the compaction ram 12 at various rates. Systems with fixed rates of travel may also be applied. Some loading systems may require compensation techniques to account for frame compliance. Rate of travel may be adjusted in some applications to a constant rate of strain on the material sample as sample height changes.

The position measurement and recording system is generally capable of indicating the height of the specimen S during the test process to the nearest 0.1 mm.

Specimen Molds

Specimen molds such as mold 15 preferably conform to the requirements of ASTM D6925. Molds are secured to the reaction frame throughout the test sequence. Molds of various diameters and lengths may be applied.

Mold End Plates

Mold end plates or plate 16 preferably conform to the requirements of ASTM D6925.

The data acquisition system preferably records at a minimum rate of 10 data sets per second throughout the test. Each data set may include for example, at minimum, a time index (second), applied pressure (kPa), and specimen height (mm). NOTE-Applied force (N) along with specimen diameter (mm) used to calculate the applied N/mm² applied is an acceptable alternative to applied pressure.

Thermometers

Preferred thermometers for the disclosed methods are armored, glass, or dial type thermometers with metal stems for determining the temperature of aggregates, asphalt binders, and asphalt mixtures between 10° C. and 232° C., with a minimum sensitivity of 3° C. or other suitable means for measuring, recording, or otherwise indicating the specimen temperature. Some loading systems are equipped with instrumentation to measure and record the specimen temperature throughout the test.

Balance

The balance preferably has a minimum capacity of 10,000 g with a sensitivity of 0.1 g. The balance preferably conforms to Specification D 4753 as a Class GP2 balance.

Ovens

Two ovens are recommended for laboratory produced specimens. One oven is generally a forced draft oven capable of maintaining the temperature required, nominally 135° C., for short term aging. At least one additional oven is generally available for heating aggregates, asphalt binders, and equipment. This oven also has a range to a minimum of 204° C., thermostatically controlled to ±3° C.

Miscellaneous

Miscellaneous equipment may include: flat bottom metal pans for heating aggregates; scoops for batching aggregates; containers for heating asphalt binders; mixing spoons; trowels; spatulas; welders gloves for handling hot equipment; 150 mm paper disks; lubricants for moving parts; laboratory timers; and mechanical mixers.

Molds and mold end plates should be clean and free of damage prior to the start of each test.

Calibration of the following items is generally verified following the manufacturer's recommendations annually: applied force, indicated height, time recorder, mold and mold end plate dimensions, oven temperature, and thermometer.

Material samples may be tested at multiple temperatures to determine the workability index at each test temperature; therefore, multiple material specimens are typically utilized, but are not required. Two material specimens are typically tested at each testing temperature with the results averaged. A single specimen may be tested at multiple temperatures.

Preparation of Aggregates—appropriate aggregate fractions are weighed and combined to a desired specimen weight. For example, generally 4600 g of aggregate are required for aggregates with combined bulk specific gravities in the range of 2.55 to 2.70. For specimens of 4600 g mass, a final measured height will be approximately 130 mm. Other specimen diameters and mass may be tested. If the test utilizes molds other than 150 mm diameter, the weight is adjusted to achieve the desired specimen final height. Details of aggregate preparation may be found in any suitable mix design manual, such as the Asphalt Institute's MS-2. SUPERPAVE™ volumetric design specimens have been shown to be of appropriate mass.

Blended aggregate specimens and asphalt binder are placed in an oven and bring to the required mixing temperature. The mixing container and all necessary mixing implements are heated to the required temperature.

A preferred laboratory mixing temperature range is typically defined as the range of temperatures where the un-aged asphalt binder has a kinematic viscosity of 170±20 mm2/s (approximately 0.17±0.02 Pa-s for an asphalt binder density of 1.000 g/cm3) measured in accordance with Test Method D 4402. Modified asphalt binders, especially those produced with polymer additives, generally do not adhere to the viscosity ranges noted.

The heated mixing bowl is charged with the dry, heated aggregate and dry mix. A crater is formed in the heated aggregate blend and the required amount of asphalt binder is weighed into the aggregate blend. Mixing is begun immediately.

The asphalt binder and aggregate is mixed as quickly and thoroughly as possible to yield an asphalt mixture having a uniform distribution of asphalt binder. A mechanical mixer is preferable for the mixing process.

Laboratory prepared material specimens require relatively short term aging prior to testing.

After completing the mixing process, the loose mix is subjected to short-term conditioning according to AASHTO R30 Mixture Conditioning of Hot Mix Asphalt (HMA) for 2 h±5 min at the conditioning temperature±3° C., and then stirred after 60±5 min to maintain uniform conditioning.

### Preparation of Field Plant Mix Material Specimens

Plant produced specimens may be sampled following procedures such as ASTM D979/D979M Standard Practice for Sampling Bituminous Paving Mixtures and ASTM D3665 Standard Practice for Random Sampling of Construction Materials.

For samples of HMA plant-produced mix, one of the following short-term aging conditions may be specified. For example, no conditioning, test immediately as produced once the specimen is at test temperature for a period of 15 minutes. Another conditioning that the user can demonstrate will replicate the design conditioning.

### Testing of Material Specimens

The material specimen is heated to the predetermined test temperature and held for 15 minutes. A temperature offset may be applied to help counter temperature loss during the test.

For construction temperature prediction models, test temperatures are typically selected to achieve workability values less than 150 kPa or greater than 170 kPa. Depending on material type, the temperature for a workability value less than or equal to 150 kPa may range from 60° C. (140° F.) for Warm Mix Asphalt, 71° C. (160° F.) Hot Mix Asphalt, to 80° C. (176° F.) for Polymer Modified materials. The temperature to achieve a workability value greater than or equal to 170 kPa may range from 104° C. (220° F.) for Warm Mix Asphalt, 120° C. (248° F.) Hot Mix Asphalt, to 150° C. (302° F.) for Polymer Modified materials.

Place a mold and mold end plates into an oven at a predetermined temperature for a minimum of 45 min prior to the testing of the first specimen (during the time the mixture is in the conditioning process). Temperature offsets may be required to help compensate for temperature loss during placement of material into the mold. Molds with heating elements may also be employed. The settings on the loading system should be verified.

At the end of the conditioning period, the specimen is brought to the desired test temperature. The loose mix specimen, mold, and mold end plates are removed from the oven. A paper disk is placed on the bottom end plate inside the mold to aid separation of the specimen after testing. The specimen is placed into the mold in a single lift using a transfer bowl or other suitable device. Segregation of the mixture in the mold is preferably minimized. After the mixture has been completely loaded into the mold, the specimen may be rodded to provide uniform constituent distribution throughout, the top of the specimen is leveled and a second paper disk is placed onto the material specimen to avoid material adhering to the second mold end plate. If required, a second end plate is installed in the mold.

The prepared specimen and mold is placed into the loading frame and the test sequence initiated. The loading frame applies a force to the specimen at a controlled rate of travel of the loading platen until the desired final stress is achieved. Alternate rates and stress parameters may be used for different applications.
Two sample strain rate/stress profiles are provided as examples of profiles that may be utilized. Alternate profiles including additional or fewer steps, different or continuously variable rates (V), and/or different stress levels (P), may be also applicable.
   3-Step Profile:
      V₁=4.0 mm/s until P₁=25 kPa is achieved, then apply rate V₂.
      V₂=1.5 mm/s until P₂=40 kPa is achieved, then apply rate V₃.
      V₃=0.05 mm/s until P₃=700 kPa is achieved, test complete.
   5-Step Profile:
      V₁=4.0 mm/s until P₁=25 kPa is achieved, then apply rate V₂.
      V₂=2.5 mm/s until P₂=50 kPa is achieved, then apply rate V₃.
      V₃=1.25 mm/s until P₃=70 kPa is achieved, then apply rate V₄.
      V₄=0.01 mm/s until P₄=90 kPa is achieved, then apply rate V₅.
      V₅=0.05 mm/s until P₅=950 kPa is achieved, test complete.

Record the time, applied force, and specimen height at least every 0.1 seconds.

At the completion of the test profile, measure and record the temperature of the specimen. For molding apparatus equipped with temperature measurement instrumentation, the specimen temperature is recorded throughout the test. The specimen is then removed from the mold.

If the loading system is a gyratory compactor, at the completion of the workability test profile, the material specimen may be compacted utilizing gyratory compaction. Specimens compacted in this manner have the advantage of further evaluation.

### Calculation or Interpretation of Results

Calculate the Normal Stress at each index point n for the test sequence:

$${σ}_{n} = \frac{{F}_{n}}{A} \qquad Equation 1$$

Where,
   σₙ=Stress at n, kPa
   Fₙ=Force at n, kN
   A=Area of cross-section, m²
   n=Index

Calculate the % Volumetric Strain at each index point n for the test sequence:

$${ɛ}_{n} = \frac{{h}_{0} - {h}_{n}}{{h}_{0}} * 100 \qquad Equation 2$$

Where,
   εₙ=Volumetric Strain at n, %
   hₙ=Specimen Height at n, mm
   h₀=Specimen Height at a predetermined stress level (i.e.: 90 kPa), mm
   n=Index

Calculate the Dongre Workability Test (DWT) Value (slope of stress vs. volumetric strain curve between 550 kPa and 650 kPa):

$$D W {T}_{T} = \frac{{σ}_{650} - {σ}_{550}}{{ɛ}_{650} - {ɛ}_{550}} \qquad Equation 3$$

Where,
   DWT_{T}=Workability at Temperature T, kPa
   σ₅₅₀=Measured stress at index nearest 550 kPa, kPa
   σ₆₅₀=Measured stress at index nearest 650 kPa, kPa
   ε₅₅₀=Volumetric Strain at index nearest 550 kPa stress, %
   ε₆₅₀=Volumetric Strain at index nearest 650 kPa stress, %

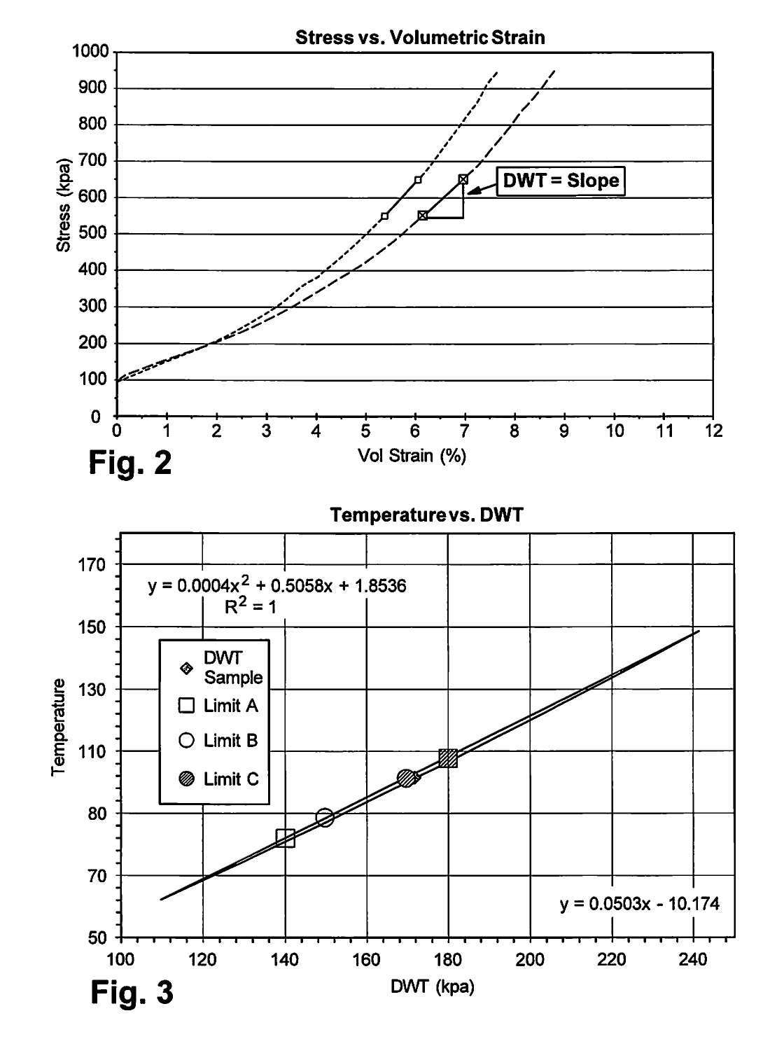

Those skilled in the art will recognize that the slope of the stress-strain curve may be evaluated at other stress levels or at other rates for certain applications. Lower slope (less steep) reflects lower workability. A representative plot of stress vs. volumetric strain as determined by Equations 1-3 is shown in FIG. 2.

### Construction Temperature Workability Predictions

For temperature workability predictions, a minimum of two workability values are required with one value preferably less than or equal to the lower construction workability target (DWT_{L}) and the second value preferably greater than or equal to the higher workability target (DWT_{H}). If the workability values do not meet these requirements, the material may be re-tested at temperatures which provide the desired values.
Workability values of 150 and 170 are believed to represent a desirable construction workability range for asphalt concrete pavement mixtures. Alternate values for workability may apply to specific construction practices or materials.

Calculate the temperature (T_{L}) corresponding to the DWT_{L} value from the data by linear regression.

$${T}_{L} = ( \frac{D W {T}_{L} - D W {T}_{2}}{D W {T}_{1} - D W {T}_{2}} ) ( {T}_{1} - {T}_{2} ) + {T}_{2} \qquad Equation 1$$

where,
   T_{L}=Predicted temperature corresponding to DWT_{L}, ° C.
   T₁=Temperature at DWT₁, ° C.
   T₂=Temperature at DWT₂, ° C.
   DWT_{L}=Low Workability DWT Target Value, kPa
   DWT₁=DWT Value≦DWT_{L}, kPa
   DWT₂=DWT Value≧DWT_{H}, kPa

Calculate the temperature (T_{H}) corresponding to the DWT_{H} value from the data by linear regression.

$${T}_{H} = ( \frac{D W {T}_{H} - D W {T}_{2}}{D W {T}_{1} - D W {T}_{2}} ) ( {T}_{1} - {T}_{2} ) + {T}_{2} \qquad Equation 2$$

where,
   T_{H}=Predicted temperature corresponding to DWT_{H}, ° C.
   T₁=Temperature at DWT₁, ° C.
   T₂=Temperature at DWT₂, ° C.
   DWT_{H}=High Workability DWT Target Value, kPa
   DWT₁=DWT Value≦DWT_{L}, kPa
   DWT₂=DWT Value≧DWT_{H}, kPa

FIG. 3 shows sample report with temperature predictions tabulated as shown in Table 3 and charted at selected workability values from test measurements.

Asphalt concrete mixtures will typically exhibit a sigmoid function shape for the workability versus temperature curve. The linear prediction calculation assumes a linear estimate is representative of the material behavior over the region of interest. For data sets with widely diverse DWT values, this estimate may not be appropriate. For data sets containing more than two temperature values, alternate prediction regressions such as polynomial fits may provide more representative predictions.

TABLE 3

| Material | Aggregate | Binder | Additive |
|---|---|---|---|
| JMF No.: | Code: | Grade: | Type: |
| Design: | Class: | % AC: | %: |
| Plant/Lab: | Supplier: | % Virgin: | |
| % RAP: | Nom.Size: | % Rec: | |

| | DWT Profile | | | | | |
|---|---|---|---|---|---|---|
| | 0 | 1 | 2 | 3 | 4 | 5 |
| Velocity (mm/S) | 4.00 | 1.00 | 0.01 | 0.05 | | |
| Stress (kPa) | 6 | 25 | 90 | 950 | | |

| | |
|---|---|
| DWT | Temperature |

| Test Results | kPa | ° C. | ° F. |
|---|---|---|---|
| Mix1 T1 | 109.7 | 62.5 | 144.5 |
| Mix1 T2 | 172.0 | 101.5 | 214.7 |
| Mix1 T3 | 241.7 | 149.0 | 300.2 |

| | |
|---|---|
| Target | Predicted |
| DWT | Temperature |

| Workability | kPa | ° C. | ° F. |
|---|---|---|---|
| Limit A | 140 | 81.7 | 179.1 |
| Limit B | 150 | 88.3 | 190.9 |
| Limit C | 170 | 101.4 | 214.5 |
| Limit D | 180 | 108.0 | 226.3 |

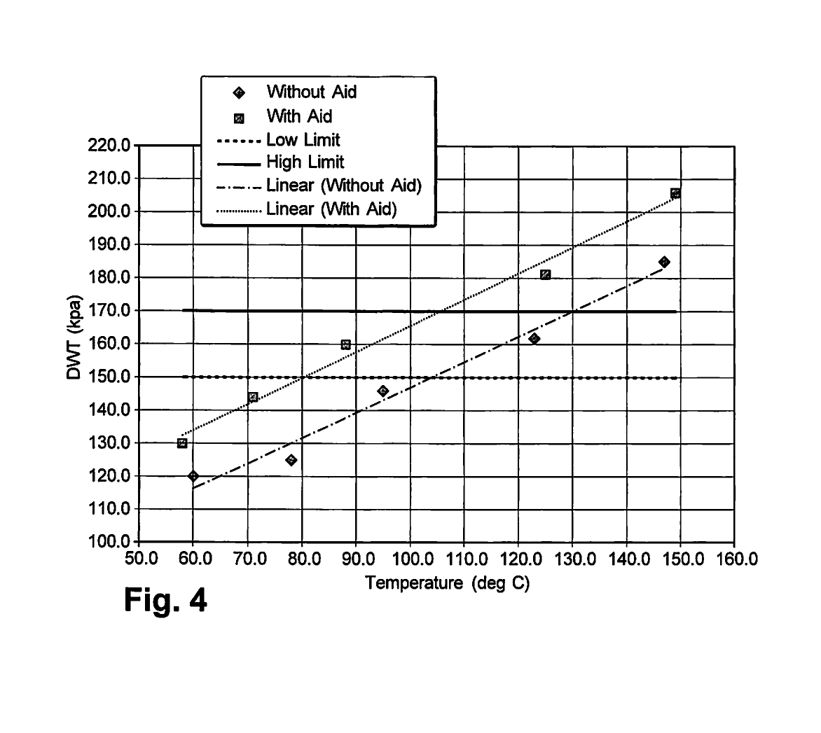

FIG. 4 represents an example of a comparison of two asphalt concrete mixtures tested in accordance with the disclosed methods at five different temperatures each. One mixture includes an additive known to act as a compaction aid to improve the construction of the pavement material at lower temperatures. The second material represents the pavement mixture without the additive. Also shown on the chart are sample DWT workability index target values, in this case 150 and 170. By evaluating the reduction in temperature for a given workability value of interest, the DWT Index/Temperature curve provides a means for quantifying the temperature reduction gained by using the compaction aid and thus represents the improvement that may be gained by the use of said compaction aid.
Those skilled in the art will recognize alternate workability values and testing temperatures will be appropriate for specific applications.

The disclosed methods provide numerous advantages over existing techniques for assessing workability and compactability of asphalt concrete mixtures in that:

No specialized equipment or training beyond that needed for typical asphalt concrete design is required. The mixture is evaluated as a composite, not as individual components. Specimen mass does not require large material batches. Workability can be easily characterized at various temperatures and/or loading rates providing an assessment of construction behavior from laboratory tests.

The disclosed test methods are simple and results are available quickly making it useful for quality control applications. The test methods are highly repeatable and thus provide reliable data.

The temperature reduction effected by the use of warm-mix additives can be determined.

The methods are capable of detecting changes in asphalt concrete mix components: binder, aggregate, warm mix additives, polymer modifiers, and other constituents. The methods are capable of resolving differences in workability due to aggregate gradation, asphalt binder grade, warm mix additives, polymer modifiers, and other constituents. Field compaction temperatures and workabilities can be predicted for various warm-mix, hot-mix and polymer modified asphalt mixes by running the test at two or more temperatures or a two or more loading rates.

What is claimed is:

1. A method for determining a material characteristic of asphalt concrete mixtures, the method comprising:
heating an asphalt concrete mixture contained in a molding apparatus to a first temperature;
placing the mixture into the molding apparatus, the molding apparatus having at least one moveable end plate;
applying a force to the mixture via the end plate at a predetermined loading rate and to a first force and to a second force;
measuring and recording the applied forces and heights of the mixture in the molding apparatus during the application of the forces, and
determining a material characteristic of the mixture by calculating a force, height relationship of the asphalt concrete mixture at the first and second force levels.

2. The method of claim 1 further comprising the step of determining a strain of the asphalt concrete mixture based on the measured heights of the mixture in the molding apparatus during the application of forces.

3. The method of claim 1 further comprising the step of determining a material characteristic of the asphalt concrete mixture by calculating a slope of a stress-strain relationship of the asphalt concrete mixture at the first and second stress levels.

4. The method of claim 1 wherein the determined material characteristic is workability.

5. The method of claim 1 wherein the determined material characteristic is compactability.

6. The method of claim 1 wherein the strain is determined as a volumetric strain based on an initial height at a predetermined stress level.

7. The method of claim 1 wherein molding apparatus is a Superpave Gyratory Compactor.

8. The method of claim 1 wherein the loading rate is constant.

9. The method of claim 1 wherein the loading rate is a constant strain rate of the material specimen.

10. The method of claim 1 wherein the loading rate is varied throughout a material stress range.

11. The method of claim 1 further comprising the steps of testing the asphalt concrete mixture with and without compaction aids to determine impact of said aids on construction properties at said temperatures.

12. The method of claim 1 wherein the determined material characteristic is used as a quality control measure.

13. A method for predicting a temperature at which a certain material characteristic occurs for an asphalt concrete mixture, the method comprising the steps of:
heating the asphalt concrete mixture to a first temperature;
placing an asphalt concrete mixture in a molding apparatus, the molding apparatus having a moveable end plate;
applying a force to the asphalt concrete mixture in the molding apparatus at a predetermined rate and through a first stress level and a second stress level;
measuring the applied force and one or more heights of the asphalt concrete mixture in the molding apparatus during the application of force;
determining a strain of the asphalt concrete mixture based on the measured heights;
determining a first material characteristic of the asphalt concrete mixture by calculating a slope of the stress-strain relationship over first and second stress levels at the first temperature;
heating the asphalt concrete mixture to a second temperature;
applying a force to the asphalt concrete mixture in the molding apparatus at a predetermined rate and through a first stress level and a second stress level;
measuring the applied force and one or more heights of the asphalt concrete mixture in the molding apparatus during the application of force;
determining a strain of the asphalt concrete mixture based on the measured heights at the second temperature;
determining a second material characteristic of the asphalt concrete mixture by calculating a slope of the stress-strain relationship over the first and second stress levels at the second temperature, and
predicting a third temperature at which a third material characteristic occurs from the from the material characteristics determined at the first and second temperatures.

14. The method of claim 13 wherein the first material characteristic is workability.

15. The method of claim 13 wherein the first material characteristic is compactability.

16. A method for predicting a temperature at which a certain material characteristic occurs for an asphalt concrete mixture, the method comprising the steps of:
heating the asphalt concrete mixture to a first temperature;
placing the asphalt concrete mixture into the molding apparatus;
applying a force to the asphalt concrete mixture in the molding apparatus in a first predetermined loading sequence through first and second stress levels;
measuring the applied force and one or more heights of the asphalt concrete mixture in the molding apparatus during the first predetermined loading sequence;
determining a strain of the asphalt concrete mixture based on the measured heights;
determining a first material characteristic of the asphalt concrete mixture by calculating a slope of the stress-strain relationship over the first and second stress levels;
applying a force to the asphalt concrete mixture in the molding apparatus in a second predetermined loading sequence through third and fourth stress levels;
measuring the applied force and one or more heights of the asphalt concrete mixture in the molding apparatus during the second predetermined loading sequence;
determining a strain of the asphalt concrete mixture based on the measured heights;
determining a second material characteristic of the asphalt concrete mixture by calculating a slope of the stress-strain relationship over the third and fourth stress levels, and
predicting a third temperature at which a certain third material characteristic occurs from the results of the first and second predetermined loading sequences.

17. The method of claim 16 wherein the first and second stress levels are the same as the third and fourth stress levels respectively.

18. The method of claim 16 wherein the material characteristic is workability.

19. The method of claim 16 wherein the material characteristic is compactability.

20. A method for determining a material characteristic of asphalt concrete mixtures during production of asphalt concrete mixtures, the method comprising the steps of:
heating the asphalt concrete mixture to a first temperature;
placing an asphalt concrete mixture into the molding apparatus;
applying a force to the asphalt concrete mixture in the molding apparatus in a predetermined loading sequence in which different forces are applied to the asphalt concrete mixture to impart different heights to the asphalt concrete mixture in the molding apparatus and through predetermined first and second stress levels;
measuring and recording the applied forces and heights of the asphalt concrete mixture in the molding apparatus during the loading sequence;
determining a strain of the asphalt concrete mixture in the molding apparatus based on the measured heights, and
determining a material characteristic of the asphalt concrete mixture by calculating a slope of a stress-strain relationship over the first and second stress levels.

21. The method of claim 20 wherein each of the steps is repeated during production of an asphalt concrete mixture and using a determined material characteristic as a quality control measure.

22. The method of claim 20 wherein the determined material characteristic is workability.

23. The method of claim 20 wherein the determined material characteristic is indicative of field compactability.

24. A method for predicting a material characteristic of an asphalt concrete mixture, the method comprising the steps of:
heating the asphalt concrete mixture to a first temperature;
placing an asphalt concrete mixture in a molding apparatus, the molding apparatus having a moveable end plate;
applying a force to the asphalt concrete mixture in the molding apparatus at a predetermined rate and through a first stress level and a second stress level;
measuring the applied force and one or more heights of the asphalt concrete mixture in the molding apparatus during the application of force;
determining a strain of the asphalt concrete mixture based on the measured heights;
determining a first material characteristic of the asphalt concrete mixture by calculating a slope of the stress-strain relationship over first and second stress levels at the first temperature;
heating the asphalt concrete mixture to a second temperature;
determining a second material characteristic of the asphalt concrete mixture by calculating a slope of the stress-strain relationship over the third and fourth stress levels, and
predicting a third material characteristic at a third temperature from the results of the first and second temperatures.

25. The method of claim 24 wherein the determined material characteristic is workability.

26. The method of claim 24 wherein the determined material characteristic is indicative of field compactability.

27. A method for predicting a material characteristic of an asphalt concrete mixture, the method comprising the steps of:
heating the asphalt concrete mixture to a first temperature;
placing the asphalt concrete mixture into the molding apparatus;
applying a force to the asphalt concrete mixture in the molding apparatus in a first predetermined loading sequence through first and second stress levels;
measuring the applied force and one or more heights of the asphalt concrete mixture in the molding apparatus during the first predetermined loading sequence,
determining a strain of the asphalt concrete mixture based on the measured heights;
determining a first material characteristic of the asphalt concrete mixture by calculating a slope of the stress-strain relationship over the first and second stress levels;
applying a force to the asphalt concrete mixture in the molding apparatus in a second predetermined loading sequence through third and fourth stress levels;
measuring the applied force and one or more heights of the asphalt concrete mixture in the molding apparatus during the second predetermined loading sequence;
determining a strain of the asphalt concrete mixture based on the measured heights;
determining a second material characteristic of the asphalt concrete mixture by calculating a slope of the stress-strain relationship over the third and fourth stress levels, and
predicting a third material characteristic at a third temperature from the results of the first and second predetermined loading sequences.

28. The method of claim 27 wherein the first and second stress levels are the same as the third and fourth stress levels respectively.

29. The method of claim 27 wherein the determined material characteristic is workability.

30. The method of claim 27 wherein the determined material characteristic is indicative of field compactability.
